(19) United States
(12) Patent Application Publication
(10) Pub. No.: US 2007/0218351 A1
(43) Pub. Date: Sep. 20, 2007

(54) BATTERY SYSTEM WITH GAS DISCHARGE DEVICE

(76) Inventors: Russell W. Boerner, Sterling Heights, MI (US); Michael A. Marchio, Clarkston, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/687,803

(22) Filed: Mar. 19, 2007

Related U.S. Application Data
(60) Provisional application No. 60/783,273, filed on Mar. 17, 2006.

(51) Int. Cl. H01M 2/12

(52) U.S. Cl. 429/88

(57) ABSTRACT

There is provided a battery system having a plurality of battery modules having joined top, bottom and side surfaces. The battery modules are connected for providing a power source. Each of the plurality of battery modules includes a vent having a discharge outlet. The vent includes a portion that extends outward from a side of the battery module. A gas manifold having a gas discharge tube extending from a first end to a second end includes a plurality of tubular ports positioned between the first and second ends of the gas discharge tube. The plurality of tubular ports extend radially outward from the gas discharge tube and are coupled to each of the vents of the plurality of battery modules.

### RELATED APPLICATION

This application claims priority of U.S. Provisional Patent Application Ser. No. 60/783,273 filed Mar. 17, 2006, which is incorporated herein by reference.

### FIELD OF THE INVENTION

The invention relates to battery systems, and with more particularity to a battery system having a gas discharge device.

### BACKGROUND OF THE INVENTION

Battery systems for use in vehicles generally include a plurality of battery modules that are interconnected to provide a power source for the vehicle. The battery modules generally include safety vents allowing for expelling gases and liquids produced by the battery modules when an internal pressure exceeds a predetermined amount. The gas produced from the charging and discharging of a battery module may be flammable gas, such as hydrogen, and thus should be vented to the external atmosphere. A gas manifold connected to the safety vents of the battery modules can route the gas to an external atmosphere relative to the vehicle.

The gas manifold should be adjustable to accommodate variations in the tolerances of the position of the plurality of battery modules. Additionally, the gas manifold should be adjustable to accommodate expansion and contraction of battery modules when in use.

There is therefore a need in the art for a battery system and gas manifold that is adjustable to accommodate tolerancing variations in a battery system. Additionally, there is a need in the art for a battery system and gas discharge manifold that is relatively easy to manufacture and provides a cost-effective part that has a long and useful service life.

### SUMMARY OF THE INVENTION

There is provided a battery system having a plurality of battery modules having joined top, bottom and side surfaces. The battery modules are connected for providing a power source. Each of the plurality of battery modules includes a vent having a discharge outlet. The vent includes a portion that extends outward from a side of the battery module. A gas manifold having a gas discharge tube extending from a first end to a second end includes a plurality of tubular ports positioned between the first and second ends of the gas discharge tube. The plurality of tubular ports extend radially outward from tie gas discharge tube and are coupled to each of the vents of the plurality of battery modules.

### BRIEF DESCRIPTION OF THE DRAWINGS

FIG. 1 is a perspective view of a portion of a battery system including a plurality of battery modules with a gas manifold attached to the vents of the plurality of battery modules;

FIG. 2 is a perspective view of a battery system including two layers of battery modules positioned on a carrier;

FIG. 3 is a perspective view of a gas manifold according to the present invention;

FIG. 4 is a side sectional view of the gas manifold of FIG. 3;

FIG. 5 is a blown up sectional view of a portion of the gas manifold detailing the tubular port and the vent including a barb.

### DETAILED DESCRIPTION OF THE PREFERRED EMBODIMENTS

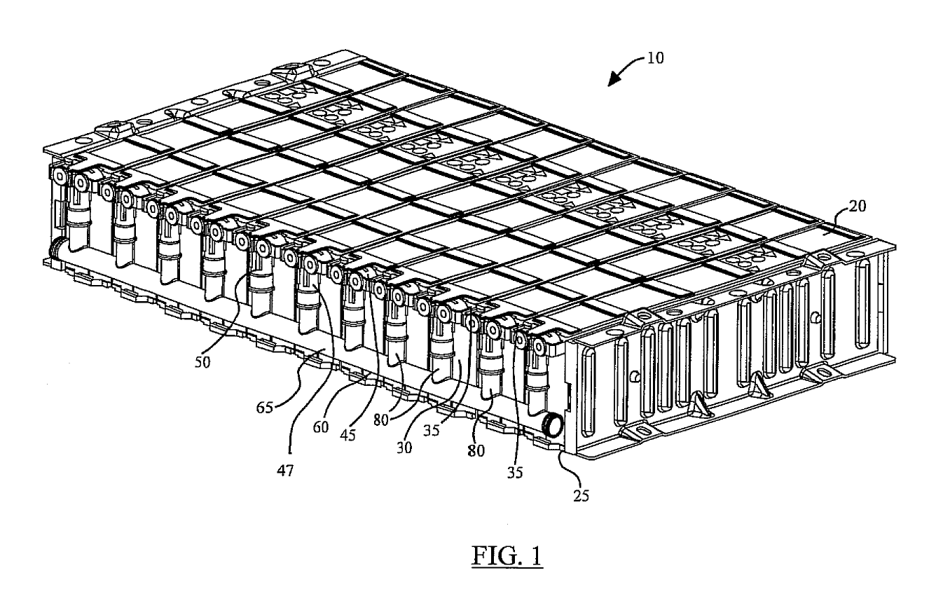

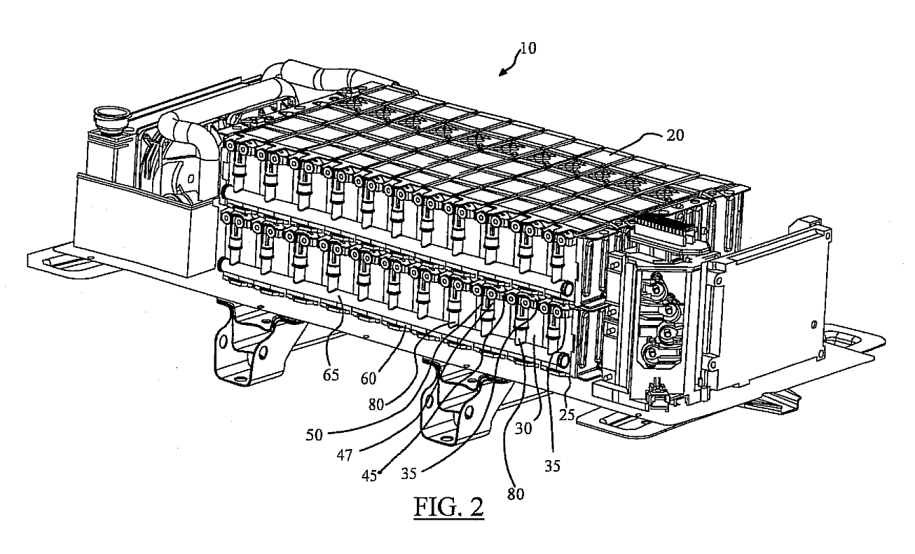

Referring to FIGS. 1 and 2, there is shown a battery system 10 according to the present invention. As can be seen, the battery system 10 includes a plurality of battery modules 15 that are interconnected to provide a power source. The plurality of battery modules 15 include joined top 20, bottom 25 and side 30 surfaces. Each of the plurality of battery modules 15 includes a vent 35 having a discharge outlet 40, best seen in FIG. 5. The vent 35 includes a portion 45 that extends outward from a side 30 of the battery module 15. The vent 35 may also include a tubular section 50 that extends downward from the portion 45 that extends outward from the side 30 of the battery module 15 and terminates at the discharge outlet 40. In one aspect, the tubular portion 50 may include a clip 47 that may be associated with a barb 55. The barb 55 may be included with the clip 47 or may otherwise be associated with the tubular section 50. The barb 55 may be operative to engage a gas manifold 60, as will be discussed in more detail below.

The battery system 10 may also include a gas manifold 60 that includes a gas discharge tube 65 that extends from a first end 70 to a second end 75. The gas manifold 60 includes a plurality of tubular ports 80 that are positioned between the first 70 and second 75 ends of the gas discharge tube 65. The plurality of tubular ports 80 extend radially outward from the gas discharge tube 65. The plurality of tubular ports 80 are coupled to each of the vents 35 of the plurality of battery modules 15.

In one aspect, the gas manifold 60 is attached to each of the plurality of battery modules 15 at the vents 35. The vents 35 are in communication with each of the modules 15 to provide an exit for gas produced within the battery module 15 to escape. The gas proceeds through the vent 35 when an internal pressure of the battery module 15 exceeds a predetermined value allowing the gas to travel into the gas manifold 60. The gas manifold 60 in one aspect may be connected to further connections (not shown) to vent the gas to an external atmosphere.

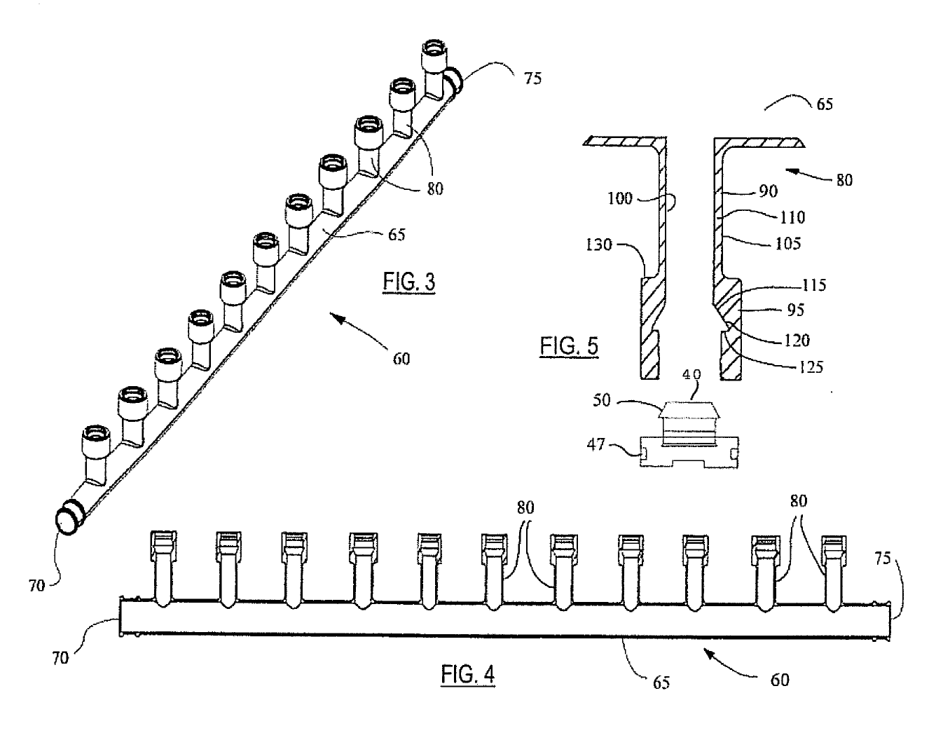

Referring to FIGS. 3, 4 and 5, there is shown the gas manifold 60 for use in the battery system 10. As can be seen, the gas manifold 60 includes a gas discharge tube 65 having a hollow interior 85 allowing for the introduction of gas from the vent 35. The plurality of tubular ports 80 are positioned between the first 70 and second 75 ends of the gas discharge tube 65. Additionally, the plurality of tubular ports 80 extend radially outward from the gas discharge tube 65. In one aspect, the plurality of tubular ports 80 may be integrally formed with the gas discharge tube 65. The gas manifold 60 may be formed of a suitable elastomeric material such as a rubber compound that may be readily molded to form the gas manifold 60. In one aspect, the plurality of tubular ports 80 are flexible for adjusting a position of the gas manifold 60 when attached to the battery modules 15.

Referring to FIGS. 4 and 5, there is shown the plurality of tubular ports 80 of the gas manifold 60 of the present invention. The plurality of tubular ports 80 include a neck portion 90 that is connected to the gas discharge tube 65 and extends longitudinally outward. An engagement portion 95 extends longitudinally from the neck portion 90. In one aspect, the neck portion 90 extends longitudinally outward a sufficient distance to allow for adjusting a position of the gas manifold 60 when attached to the battery module 15. The neck portion 90 may extend longitudinally outward a distance of from 1 to 170 millimeters allowing for the adjustment described above.

Again referring to FIG. 5, the neck portion 90 and engagement portion 95 include an inner surface 100 separated from an outer surface 105 by a thickness 110. In one aspect, the thickness 110 of the neck portion 90 is less than the thickness of the engagement portion 95. The thickness 110 of the neck portion 90 may be from 0.5 to 6 millimeters allowing displacement of the tubular ports 80 relative to the gas discharge tube 65. In this manner, the neck portion 90 may flex or bend to allow for variations in the positional tolerance of the vents 35 of the battery modules 15.

Additionally, the neck portion 90 may be formed of a material having a flexibility that is greater than that of the engagement portion 95. The material of the neck portion 90 may be the same material of the engagement portion 95 but has been treated in a manner to allow for a greater flexibility, or the neck portion 90 may be formed of a material different than that of the engagement portion 95, again to allow for a difference in the flexibility of the various portions.

Referring to FIG. 5, tie inner surface 100 of the engagement portion 95 may include an attachment feature 115 formed thereon. As can be seen in the figure, the attachment feature 115 includes an angled surface 120 angling outward from the inner surface 100 toward the outer surface 105 of the engagement portion 95. The angled surface 120 terminates at a ledge 125 for engaging the barb 55 associated with the vent 35.

In use, the gas manifold 60 may be attached to the plurality of battery modules 15 of the battery system 10 by pressing the plurality of tubular ports 80 over the plurality of barbs 55 associated with the vents 35. A raised ridge 130 formed on the outer surface 105 of the tubular ports 80 may be used to push the tubular port 80 over the barbs 55 associated with the vents 35. The barb 55 associated with the vent 35 slides along the inner surface 100 of the tubular port 80 along the angled surface 120 until a portion of the barb 55 is received by the ledge 125. In this manner, the flexibility of the tubular ports 80 in conjunction with the engagement of the barb 55 with the ledge 125 securely retains the tubular port 80 to each of the vents 35. The neck portion 90 of the tubular port 80 extends a sufficient distance from the gas discharge tube 65 allowing it to flex or adjust to accommodate various positional tolerances of the battery modules 15. Additionally, the thickness of the neck portion 90 may be less than the thickness of the engagement portion 95, again allowing it to flex and adjust to accommodate the positional tolerance of the battery modules 15.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A gas manifold for use with a battery module comprising:
a gas discharge tube extending from a first end to a second end;
a plurality of tubular ports positioned between the first and second ends of the gas discharge tube, the plurality of tubular ports extending radially outward from the gas discharge tube;
wherein the plurality of tubular ports are flexible for adjusting a position of the gas manifold when attached to the battery module.

2. The gas manifold of claim 1 wherein each of the plurality of tubular ports includes a neck portion connected to the gas discharge tube and extending longitudinally outward and an engagement portion extending longitudinally from the neck portion.

3. The gas manifold of claim 2 wherein the neck portion extends longitudinally outward a sufficient distance to allow for adjusting a position of the gas manifold when attached to the battery module.

4. The gas manifold of claim 3 wherein the neck portion extends longitudinally outward a distance of from 1 to 170 millimeters.

5. The gas manifold of claim 2 wherein the neck portion and engagement portions include an inner surface separated from an outer surface by a thickness.

6. The gas manifold of claim 5 wherein the thickness of the neck portion is less than the thickness of the engagement portion.

7. The gas manifold of claim 5 wherein the thickness of the neck portion is from 0.5 to 6 millimeters allowing displacement of the tubular ports relative to the gas discharge tube.

8. The gas manifold of claim 2 wherein the neck portion has a material flexibility greater of the engagement portion.

9. The gas manifold of claim 2 wherein the neck portion is formed of a material having flexibility greater than a material of the engagement portion.

10. The gas manifold of claim 2 wherein the inner surface of the engagement portion includes an attachment feature formed thereon.

11. The gas manifold of claim 10 wherein the attachment feature includes an angled surface angling outward from the inner surface toward the outer surface of the engagement portion, the angled surface terminating at a ledge.

12. A battery system comprising:
a plurality of battery modules having joined top, bottom and side surfaces, the plurality of battery modules connected for providing a power source, each of the plurality of battery modules having a vent, the vent having a portion extending outward from a side of the battery module; and
a gas manifold having a gas discharge tube extending from a first end to a second end and a plurality of tubular ports positioned between the first and second ends of the gas discharge tube, the plurality of tubular ports extending radially outward from the gas discharge tube and coupled to each of the vents of the plurality of battery modules.

13. The battery system of claim 12 wherein the plurality of tubular ports are flexible for adjusting a position of the gas manifold when coupled to each of the vents of the plurality of battery modules.

14. The battery system of claim 12 wherein each of the plurality of tubular ports includes a neck portion connected to the gas discharge tube and extending longitudinally outward and an engagement portion extending longitudinally from the neck portion.

15. The battery system of claim 14 wherein the neck portion extends longitudinally outward a sufficient distance to allow for adjusting a position of the gas manifold when attached to the battery module.

16. The battery system of claim 14 wherein the neck portion and engagement portions include an inner surface separated from an outer surface by a thickness.

17. The battery system of claim 16 wherein the inner surface of the engagement portion includes an attachment feature formed thereon, the attachment feature having an angled surface angling outward from the inner surface toward the outer surface of the engagement portion, the angled surface terminating at a ledge.

18. The battery system of claim 17 wherein the vent includes a tubular section extending downward from the portion extending outward from the side of the battery module.

19. The battery system of claim 17 wherein the vent includes a barb associated therewith, the barb operative to engage the angled surface and ledge of the attachment feature formed on the inner surface of the engagement portion for coupling the plurality of tubular ports to each of the vents.

20. A battery system comprising:
a plurality of battery modules having joined top, bottom and side surfaces, the plurality of battery modules connected for providing a power source, each of the plurality of battery modules having a vent, the vent having a portion extending outward from a side of the battery module; and
a gas manifold having a gas discharge tube extending from a first end to a second end and a plurality of tubular ports positioned between the first and second ends of the gas discharge tube, the plurality of tubular ports extending radially outward from the gas discharge tube and coupled to each of the vents of the plurality of battery modules wherein the plurality of tubular ports are flexible for adjusting a position of the gas manifold when coupled to each of the vents of the plurality of battery modules.
